(19) United States
(12) Patent Application Publication
(10) Pub. No.: US 2022/0108359 A1
(43) Pub. Date: Apr. 7, 2022

(54) SYSTEM AND METHOD FOR CONTINUOUS AUTOMATED UNIVERSAL RATING AGGREGATION AND GENERATION

(71) Applicant: Wisely Labs, Inc., Seattle, WA (US)

(72) Inventors: Joseph Dieter, Seattle, WA (US); Dale Almasy, Seattle, WA (US)

(21) Appl. No.: 17/493,766

(22) Filed: Oct. 4, 2021

Related U.S. Application Data
(60) Provisional application No. 63/087,772, filed on Oct. 5, 2020.

(51) Int. Cl. G06Q 30/02; H04L 67/55; G06F 40/279

(52) U.S. Cl. CPC G06Q 30/0282; G06F 40/279; H04L 67/26

(57) ABSTRACT

Techniques are provided for retrieving media resources, analyzing those media resources to select a subject to be rated, and determining a subset of the retrieved media resources that include references to the selected subject. For each of the determined subset of retrieved media resources, one or more characteristics of the selected subject is quantified based on the references to the selected subject included by the retrieved media resource, and the media resource itself is weighted according to one or more determined weighting factors. An initial aggregated rating is generated for the selected subject, including by applying the determined weighting factors to the media resource and associated quantified characteristics. Additional media resources are identified and monitored in order to continuously update or otherwise modify the generated initial aggregated rating of the selected subject.

### CROSS-REFERENCE TO RELATED APPLICATIONS

This application claims the benefit of U.S. Provisional Patent Application No. 63/087,772, filed Oct. 5, 2020, which is hereby incorporated by reference in its entirety.

### TECHNICAL FIELD

The following disclosure relates generally to techniques for generating qualitative assessments and quantitative ratings from multiple media resources, as well as techniques for providing quantitative aggregation of such resources.

### BACKGROUND

An average adult in the United States has been estimated to make approximately 35,000 choices per day, a large number of which may include decisions regarding particular products to purchase. To the extent that a “right” choice exists for such decisions, many individuals have expressed a belief that the merits of those decisions may be appropriately judged by how “informed” the decision-maker feels at the time of purchase. However, it is also been estimated that there are approximately 2 million news articles published on the Internet every day. As of this writing, there are approximately 4 trillion searchable webpages using a popular search engine, a large number of which exist in order to express a qualitative assessment and/or quantified rating of products, services, and other subjects.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment that includes an Automated Universal Ratings (“AUR”) system as well as various computing systems associated with one or more information providers communicatively coupled to the Automated Universal Ratings system.

FIG. 2 is a schematic diagram of metadata schema generated and utilized by one embodiment of an Automated Universal Ratings system in accordance with at least some of the techniques described herein.

FIG. 3 is a block diagram illustrating a computing system suitable for executing an embodiment of an Automated Universal Ratings system that performs at least some techniques described in the present disclosure.

FIGS. 4A-4D provide a block diagram illustrating an overview of certain operations performed by an embodiment of an Automated Universal Ratings system in accordance with techniques described herein.

FIG. 5 is a block diagram illustrating an overview of additional operations according to an embodiment of an Automated Universal Ratings system in accordance with certain techniques described herein.

### BRIEF SUMMARY

In order to provide targeted information to potential decision-makers regarding potential purchases and other decisions, an automated approach to aggregating sources of qualitative assessments and/or quantified ratings regarding particular specified or unspecified products, services, and other items is provided. In particular, a system and methods are provided for retrieving media resources, analyzing those media resources to select a product or other subject to be rated, and determining a subset of the retrieved media resources that include references to the selected subject. For each of the determined subset of retrieved media resources, one or more characteristics of the selected subject is quantified based on the references to the selected subject included by the retrieved media resource, and the media resource itself is weighted according to one or more determined weighting factors. An initial aggregated rating is generated for the selected subject, including by applying the determined weighting factors to the media resource and associated quantified characteristics. In certain embodiments, additional media resources may be identified and monitored in order to continuously update or otherwise modify the generated initial aggregated rating.

### DETAILED DESCRIPTION

The present disclosure is directed to techniques for generating one or more quantified aggregate ratings for products, services, media, employers, institutions (such as educational or healthcare institutions), people, and other subjects that may serve as a focus of public discussion or review, such as discussions or reviews embodied in computer-accessible media resources.

As used herein, a “media resource” refers to any textual, graphical, audiovisual or other computer-accessible media, and may or may not include references to one or more subjects for rating. Furthermore, it will be appreciated that although the discussion herein generally relates to and uses the terms “subject” or “product” when describing various techniques, as used herein such “subject” may refer to any product, item, service, media content, person, organization, institution, or any other subject that may serve as a focus of discussion or review within or by computer-accessible media resources. For example, techniques described herein may be implemented with respect to a mobile computing device, a university, a politician or other celebrity, a manufacturer, or any other subject in order to generate one or more quantified ratings for that subject.

In various embodiments, one or more computing devices configured to provide an AUR system may receive indications of multiple media resource identifiers from various sources, and may perform additional operations in order to obtain such media resource identifiers. The AUR system may then retrieve information representing a media resource associated with each of the indicated media resource identifiers, and analyze such retrieved information in order to select a subject to be rated by the AUR system. For example, the AUR system may analyze such information representing multiple critical review resources (such as websites producing and/or hosting professional critical reviews of various subjects), consumer review resources, social media resources, and/or ecological impact resources. Via such analysis, in certain embodiments the AUR system may determine one or more subjects that fulfill one or more predefined criteria in order to select a subset of such subjects for providing an aggregated quantified rating of each selected subject. In various embodiments, the selection of a subject for ratings generated by the AUR system may be based on a variety of factors, non-limiting examples of which may include current relevance (as reflected via a “velocity” or “virality” of the subject on social media, via press coverage, via anticipation of release, etc.), branding strength (as may be indicated by manufacturer market share, revenue generation, social media followers, history of previous iterations or product lines, previous analyses of similar subjects, etc.), or other factors.

Once a subject has been selected for analysis and rating by the AUR system, in certain embodiments the AUR system may determine a subset of the retrieved media resources that each include references to the selected subject, such as by excluding from analysis those media resources that do not include such references, or that include such references but do so in a manner that fails to satisfy one or more defined relevance thresholds. In various embodiments, the selection of media resources to analyze with respect to a selected subject may be based on a variety of factors, non-limiting examples of which may include credibility (such as may be evidenced by site traffic, existing numeric or other ratings, a quantity of reviews associated with the media resource, etc.), resource strength (such as may be evidenced by an assessed length of the media resource, an assessed comment quality associated with the media resource, a quantity/quality of reviews provided by an author or other content creator with respect to the media resource, a quantity/quality of reviews provided by the author or other content creator to other media resources, etc.), or other factors.

In at least some embodiments, for each of the determined subset of retrieved media resources, the AUR system may quantify one or more characteristics of the selected subject based on an analysis of that media resource. For example, the AUR system may perform natural-language analysis or other analyses of various portions of the media resource in order to quantify one or more references to the selected subject included by the media resource, such as to distinguish positive discussion of the selected subject from negative discussion of the selected subject, either generally or with respect to particular characteristics of the subject. In addition, the AUR system may analyze the retrieved media resource to determine one or more weighting factors to use with respect to the quantification of those characteristics. For example, the AUR system may determine to apply a lesser relative weight to a minor reference to the selected subject in a social media discussion, and/or to apply a greater relative weight to a consumer review or other discussion that is specifically devoted to the selected subject. In at least some embodiments, such weighting factors may be based at least in part on previous analyses of media resources related to other subjects, such as if a publication or website containing the particular media resource has been determined by the AUR system to be associated with one or more predispositions (biases) with respect to subjects sharing certain criteria. For example, a publication devoted to products released by Apple, Inc., may be determined by the AUR system to typically provide more positive discussion of such products than products released by other competing manufacturers, and may be associated with a lesser relative weight than publications without such biases.

Non-limiting examples of factors that may be utilized in certain embodiments of the AUR system to quantify subject characteristics for a particular media resource may include credibility (in a manner similar to that described above with respect to the selection of media resources for analysis); resource strength (again, in a manner similar to that described above with respect to the selection of media resources for analysis); impact, such as may be evidenced by content associated with and/or responsive to the media resource (e.g., social media “views,” “likes,” “shares,” “re-tweets,” etc.); subject-independent keywords (positive, negative, or neutral); subject-specific keywords, such as may be indicative of pricing, specifications, ecological and/or environmental impact (e.g., indicators related to product packaging, business practices, effects of use, etc.), and various subject-related experience indicators (e.g., indicators related to product design, user interface, functions and features, accessories, packaging, etc.).

In certain embodiments, the AUR system may generate an initial aggregated rating for a selected subject by applying the determined weighting factors to the corresponding quantified characteristics of the selected subject. In addition, in at least some embodiments the AUR system may further provide additional ratings content for the selected subject. For example, in addition to an aggregated quantified rating for a selected subject, the AUR system may determine relevant keywords related to that subject, and provide such determined relevant keywords to one or more users of the AUR system in order to facilitate publication of a written, audiovisual, or other review of the selected subject.

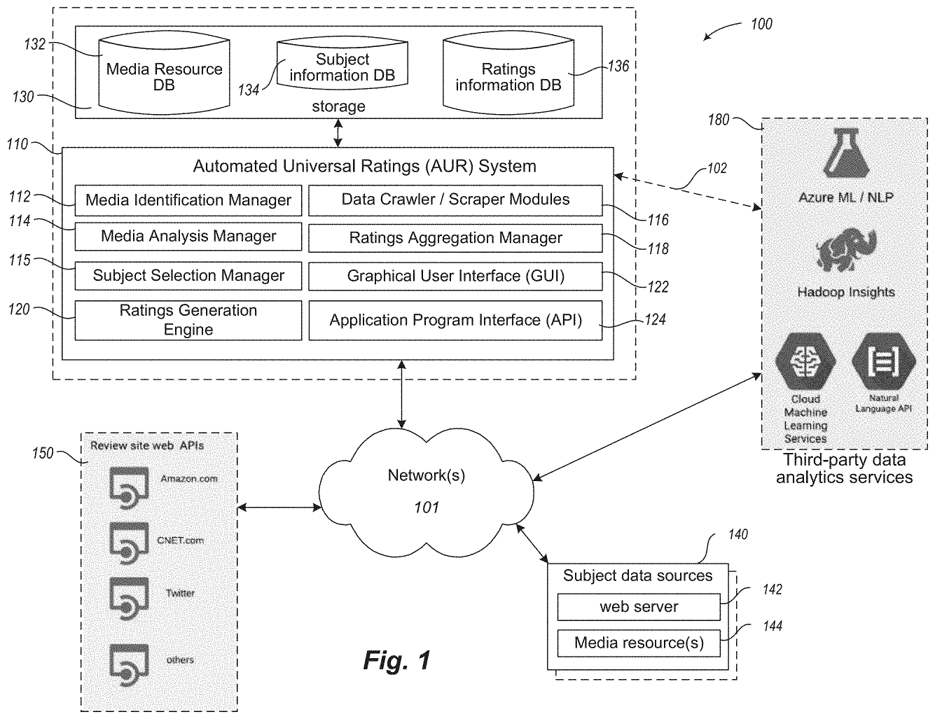

FIG. 1 is a schematic diagram of a networked environment 100 that includes an embodiment of an Automated Universal Ratings (“AUR”) system 110 in accordance with techniques described herein. In addition, the networked environment 100 includes subject data sources 140 comprising one or more computing systems not separately depicted, review site APIs (Application Program Interfaces) provided by one or more computing systems not separately depicted, and third-party data analytics services 180 also comprising one or more computing systems not separately depicted, and storage components 130. The subject data sources 140, review site APIs 150, third-party data analytics services 180 are communicatively coupled to the AUR system via one or more computer networks 101. In various embodiments, storage components 130 may be operated by a third-party data storage service provider, such as a data storage service provider that may provide various cloud-based storage services; in other embodiments, the storage components 130 may be integrated into the AUR system 110 directly, and may be operated by a universal ratings service provider that operates the AUR system. Each of the subject data sources 140 may, in at least the depicted embodiment, include one or more media resources 144, and may include and/or be provided by a Web server 142. Furthermore, in various circumstances and embodiments, one or more of the review web sites operating one or more of review site APIs 150, and/or one or more of the third-party data analytics services 180, may operate and/or include an embodiment of an AUR system, either separately or in combined use with the AUR system 110, such as to perform analysis and rating functions locally with respect to computing systems provided by such entities.

In the depicted embodiment, the AUR system 110 includes a media identification manager 112; media analysis manager 114; subject selection manager 115; data crawler/scraper modules 116; ratings aggregation manager 118; and ratings generation engine 120, as well as a graphical user interface (GUI) manager 122 and an application program interface (API) 120 (such as to provide programmatic access to various functionality of the AUR system by remote executing software programs). The storage components 130 include media resource database 132, subject information database 134, and ratings information database 136.

In various embodiments and scenarios, one or more of the elements depicted within the networked environment 100 of FIG. 1 may include and/or be communicatively coupled to additional components not depicted for the sake of clarity, such as various computing systems, additional data storage, and other additional components.

In certain embodiments the AUR system 110 may perform such analysis and other processing of media resource identifiers and/or corresponding media resources in real-time that is, as such identifiers are received from one or more users and/or one or more components of the AUR system. For example, data crawler/scraper modules 116 and/or media analysis manager 114 may identify additional media resource identifiers during analysis of an initial collection of media resource identifiers, and may recursively provide such additional identified media resource identifiers to the AUR system 110 for concurrent or subsequent processing. Moreover, in certain embodiments and scenarios, such identified media resource identifiers and media resources may be stored (such as via storage components 130) for later analysis, such as to modify a previously generated aggregated rating of a particular subject based on those additional identified media resources. In various embodiments, the AUR system 110 may perform such additional analysis and rating modification analysis upon request, periodically (such as at predefined and/or user-specified intervals), after receiving a predefined quantity of additional media resources for analysis, or in response to other events.

In various embodiments, each of the subject data sources 140 may be associated with one or more unique media resource identifiers, such as one or more unique IP addresses, URLs (uniform resource locators), or other unique identifier. In certain embodiments, the AUR system 110 may obtain such media resource identifiers from multiple sources, such as from one or more users of the AUR system; social media sources; previous analyses related to other subjects, resource directories, indexes, or other listings; or other sources. In certain embodiments, for each media resource retrieved from one of the subject data sources 140, the AUR system 110 may analyze characteristics of the retrieved media resource in order to identify characteristics associated with that media resource. Non-limiting examples of such media resource characteristics may include contents of the media resource (e.g., keywords, an embedded URL, etc.); a media resource type; an author or other content creator associated with the media resource; and intended audience of the media resource; a length of the media resource; a volume of media resources directed to or from one or more users associated with the media resource, or associated with similar media resources; metadata associated with the media resource; and other characteristics. In addition to analyzing characteristics of media resources, in certain embodiments the AUR system 110 may perform various comparisons with previously analyzed versions of the media resource and/or similar media resources, such as to compare a current version of the media resource with a version previously analyzed by the AUR system or otherwise, such as to determine if there are additional references to a selected subject within the current version of the media resource that were not included by the media resource when it was previously analyzed.

In the depicted embodiment of FIG. 1, the network(s) 101 is a publicly accessible network of linked networks, possibly operated by various distinct parties, such as the Internet, although in other embodiments the network 101 may have other forms. For example, the network 101 may instead be a private network, such as, a corporate or university network that is wholly or partially inaccessible to non-privileged users. In still other embodiments, the network 101 may include both private and public networks, with one or more of the private networks having access to and/or from one or more of the public networks. Furthermore, the network 101 may include various types of wired and/or wireless networks in various situations. In addition, in this illustrated example of FIG. 1, the review sites 150 and third-party data analytics services 180 may use client computing systems and/or other client devices that are not specifically depicted in order to interact with the AUR system 110, such as to obtain various described functionality via the network(s) 101, and in doing so may provide various types of information to the AUR system 110. Moreover, in certain embodiments, the various users and service providers depicted within the networked environment 100 may interact with the AUR system 110 and/or one or more other users and service providers using an optional private or dedicated connection, such as one of dedicated connections 102. For example, dedicated connections 102 may include one or more VPN (Virtual Private Network) connections.

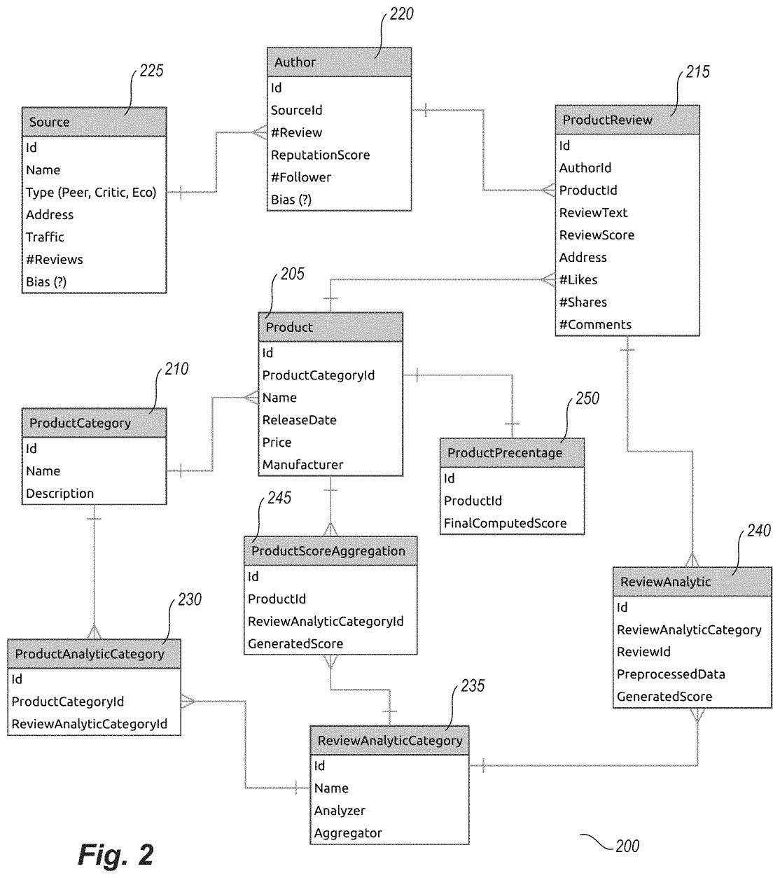

FIG. 2 is a schematic diagram of metadata schema 200, such as may be generated and utilized by one embodiment of an Automated Universal Ratings system in accordance with at least some of the techniques described herein. It will be appreciated that in various embodiments, portions of the metadata schema 200 depicted in FIG. 2 may be omitted or modified while remaining consistent with the described techniques; similarly, in various embodiments, additional metadata may be utilized within metadata schema relevant to such embodiments, and also remain consistent with the described techniques.

In the particular embodiment of FIG. 2, the metadata schema 200 indicates that each member/instance of a Product class 205 includes product-specific attributes corresponding to Id, ProductCategoryId, Name, ReleaseDate, Price, and Manufacturer. The Product class is linked to ProductCategory class 210, each member/instance of which includes category-specific attributes corresponding to Id, Name, and Description. The Product class is additionally linked to ProductReview class 215, each member/instance of which includes review-specific attributes corresponding to Id, AuthorId, ProductId, ReviewText, ReviewScore, Address, a quantity of social media likes indicated as a “#Likes” attribute, a quantity of social media shares indicated as a “#Shares” attribute, and a quantity of social media comments indicated as a “#Comments” attribute. Various additional connections between such metadata classes and instances will be readily appreciated. As one non-limiting example, it will be appreciated that the ProductCategoryId attribute within the Product class 205 corresponds to the Id attribute of the linked ProductCategory class 210, and so on.

The ProductReview class 215 is additionally linked to Author class 220, each member/instance of which includes author-specific attributes corresponding to Id, SourceId, a quantity of reviews associated with an author indicated as the “#Review” attribute, ReputationScore, a quantity of social media followers associated with an author indicated as a “#Follower” attribute, and a Bias attribute, such as to indicate one or more known biases associated with the author. For example, a Bias attribute may indicate that an author has been determined by the AUR system to more favorably rate products provided by a certain manufacturer, less favorably rate products originating from one or more nationalities or jurisdictions, etc. The Author class 220 is additionally linked to Source class 225, each member/instance of which includes source-specific attributes corresponding to Id, Name, Type (which is an indication of whether the source instance is categorized as a “Peer”, “Critic”, or “Eco” type of review source), Address, Traffic, #Reviews, and a Bias attribute to indicate whether a particular source has been determined by the AUR system to have a known bias of some kind, in a manner similar to that described above with respect to Author class 220.

The ProductCategory class 210 is additionally linked to ProductAnalyticCategory class 230, each member/instance of which includes category-specific attributes corresponding to Id, ProductCategoryId, and ReviewAnalyticCategoryId. The ProductAnalyticCategory class 230 is further linked to ReviewAnalyticCategory class 235, each member/instance of which includes specific attributes corresponding to Id, Name, Analyzer, and Aggregator. The ReviewAnalyticCategory class 235 is further linked to ReviewAnalytic class 240, each member/instance of which includes specific attributes corresponding to Id, ReviewAnalyticCategory, ReviewId, PreprocessedData, and GeneratedScore.

The Product class 205 is further linked to ProductScoreAggregation class 245, each member/instance of which includes specific attributes corresponding to Id, ProductId, ReviewAnalyticCategoryId, and GeneratedScore. In addition, the Product class 205 is further linked to ProductPercentage class 250, each member/instance of which includes specific attributes corresponding to Id, ProductId, and FinalComputedScore. It will be appreciated that in various embodiments and scenarios, the FinalComputedScore attribute may reflect one or more of an initial computed score, a modified computed score based on subsequent analysis of additional sources and reviews, or a “final” computed score not subject to additional subsequent modification, as discussed elsewhere herein.

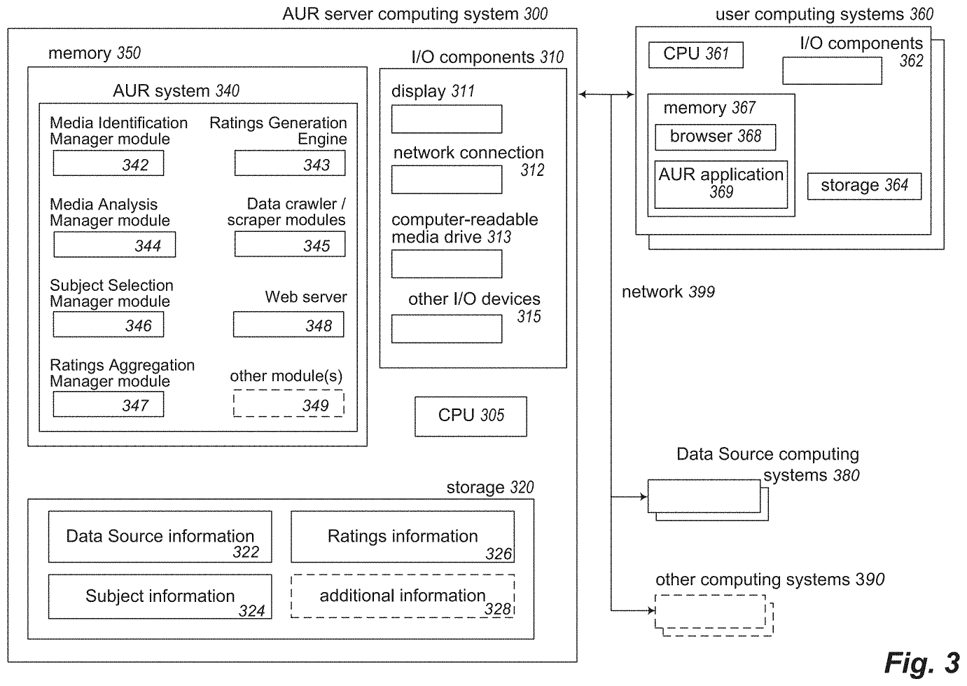

FIG. 3 is a block diagram illustrating an embodiment of a server computing system 300 executing an implementation of an AUR system 340. The server computing system 300 and AUR system 340 may be implemented using a plurality of circuits that, when in combined operation, are suitable for performing and configured to perform at least some of the techniques described herein. In the illustrated embodiment, the server computing system 300 includes one or more hardware central processing units (“CPU”) or other processors 305, various input/output (“I/O”) components 310, storage 320, and non-transitory memory 350, with the illustrated I/O components including a display 311, a network connection 312, a computer-readable media drive 313, and other I/O devices 315 (e.g., keyboards, mice or other pointing devices, microphones, speakers, GPS receivers, etc.). The server computing system 300 and AUR system 340 may communicate via one or more networks 399 (e.g., the Internet, one or more cellular telephone networks, one or more private computer networks, etc.) with other computing systems, such as user computing systems 360, data source computing systems 380, and other computing systems 390. Some or all of the other computing systems may similarly include some or all of the types of components illustrated for server computing system 300 (e.g., to have an AUR system client application 369 executing in non-transitory memory 367 of a user computing system 360 in a manner analogous to AUR system 340 in non-transitory memory 350).

In the illustrated embodiment, an embodiment of the AUR system 340 executes in memory 350 in order to perform at least some of the described techniques, such as by using the processor(s) 305 to execute software instructions of the AUR system in a manner that configures the processor(s) 305 and computing system 300 to perform automated operations that implement those described techniques. As part of such automated operations, the AUR system 340 and/or other optional programs or modules 349 executing in non-transitory memory 350 may store and/or retrieve various types of data, including in the example database data structures of storage 320. In this example, the data used may include various types of data source information in database (“DB”) 322, various types of subject information in DB 324, various types of ratings information in DB 326, and/or various types of additional information 328, such as various user or analytics information. The illustrated embodiment of the AUR system 340 includes media identification manager module 342 (e.g., in a manner corresponding to media identification manager 112 of FIG. 1), ratings generation engine 343 (e.g., in a manner corresponding to ratings generation engine 120 of FIG. 1), media analysis manager module 344 (e.g., in a manner corresponding to media analysis manager 114 of FIG. 1), data crawler/scraper modules 345 (e.g., in a manner corresponding to data crawler/scraper modules 116 of FIG. 1), subject selection manager module 346 (e.g., in a manner corresponding to subject selection manager 115 of FIG. 1), ratings aggregation manager module 347 (e.g., in a manner corresponding to ratings aggregation manager 118 of FIG. 1), Web server 348, and (optionally) other programs and components 349.

It will be appreciated that server computing system 300 and the other computing systems depicted within FIG. 3 are merely illustrative and are not intended to limit the scope of the present disclosure. The systems and/or devices may instead each include multiple interacting computing systems or devices, and may be connected to other devices that are not specifically illustrated, including through one or more networks such as the Internet, telephony or other carrier-provided networks, the Web, or one or more private networks. More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, biometric monitoring devices, digital music player devices, handheld gaming devices, PDAs, wireless phones, pagers, electronic organizers, Internet appliances, television-based systems (e.g., using set-top boxes and/or personal/digital video recorders), and various other consumer subjects that include appropriate communication capabilities. In addition, the functionality provided by the illustrated AUR system 340 may in some embodiments be distributed in various components and/or modules other than those specifically illustrated. Similarly, in some embodiments, some of the functionality of the AUR system 340 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the AUR system 340 and/or AUR client software executing on devices 360) and/or data structures, such as by execution of software instructions of the one or more software programs and/or by storage of such software instructions and/or data structures. Furthermore, in some embodiments, some or all of the systems and/or components may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program subjects may also take other forms in other embodiments. Accordingly, embodiments of the present disclosure may be practiced with other computer system configurations.

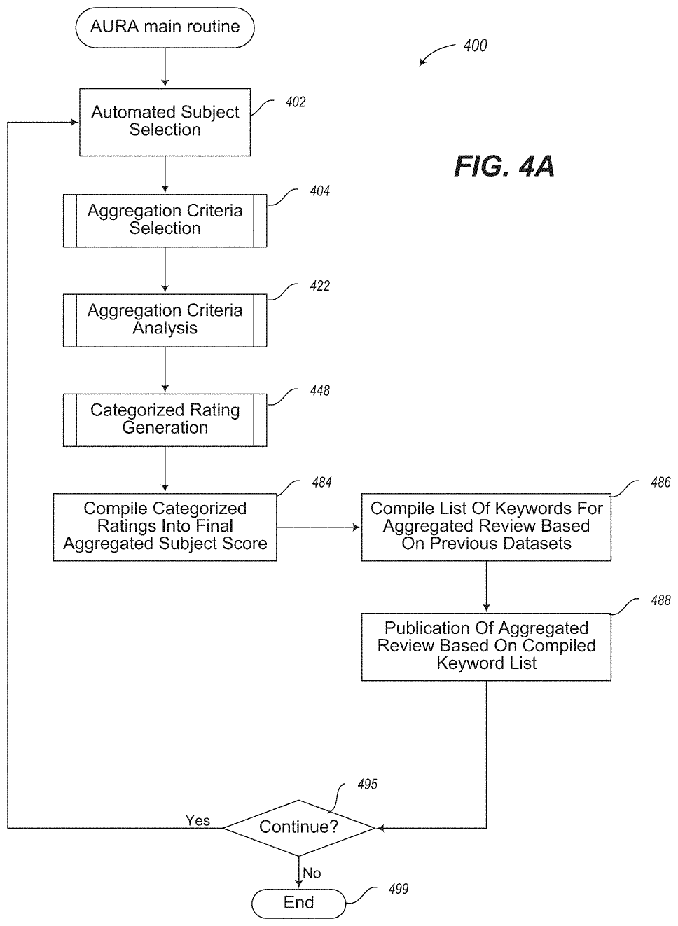

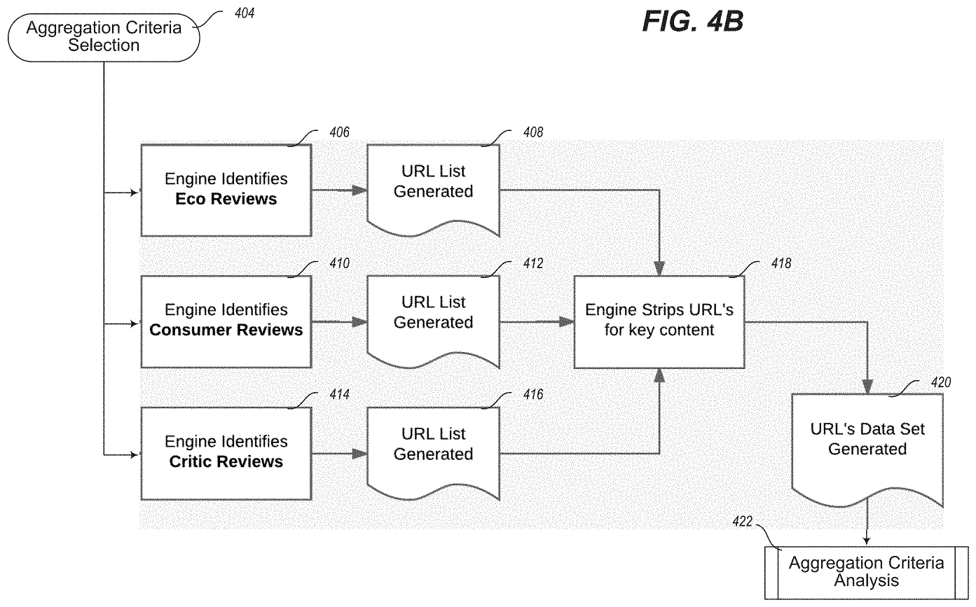

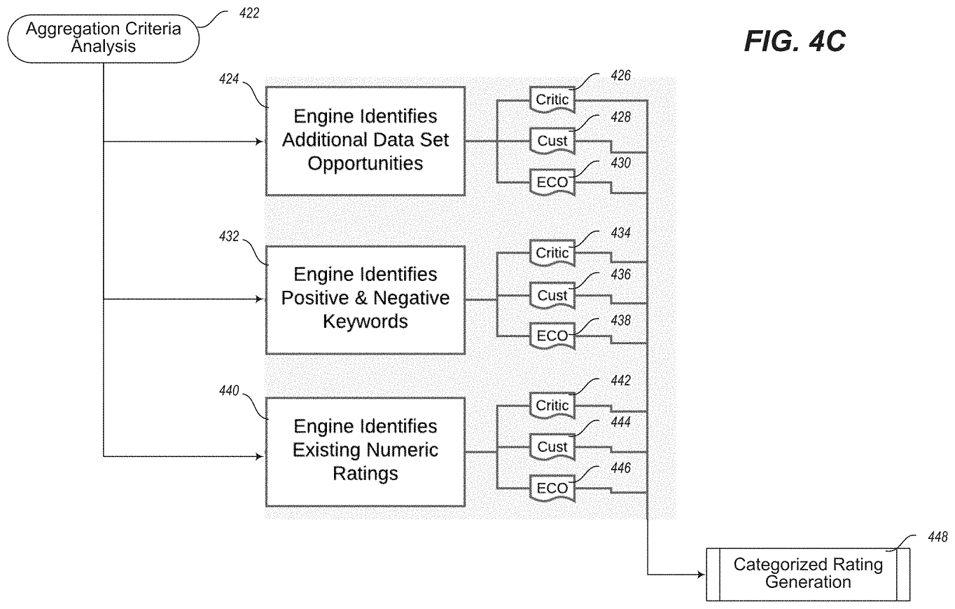

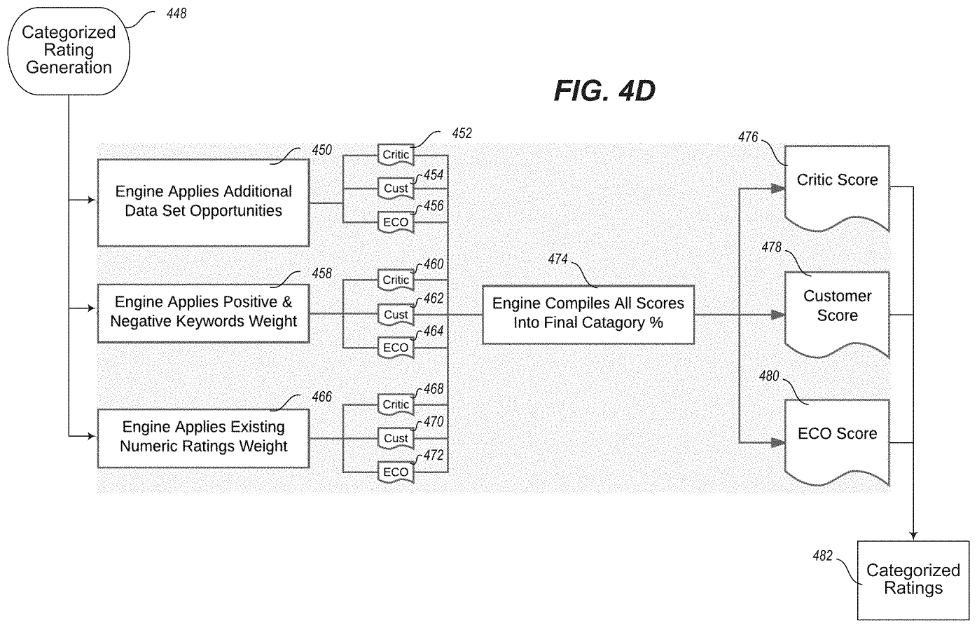

FIGS. 4A-4D illustrate an overview of certain operations performed by an embodiment of an Automated Universal Ratings system in accordance with techniques described herein. The routine 400 may, for example, be performed by CPU(s) 305 as part of executing AUR system 340 (as depicted in FIG. 3), or by the AUR system 110 of FIG. 1.

The routine 400 of FIG. 4 begins at block 402 of FIG. 4A, in which a processor-based device performs automated operations (such as via Subject Selection Manager 115 of FIG. 1 and/or Subject Selection Manager module 346 of FIG. 3) to select a subject for review, such as by receiving indications of multiple media resource identifiers (e.g., multiple URLs or other resource identifiers), retrieving (such as via Media Identification Manager 112 of FIG. 1 and/or Media Identification Manager module 342 of FIG. 3) one or more media resources associated with each of those multiple media resource identifiers, and analyzing (such as via Media Analysis Manager 114 of FIG. 1 and/or Media Analysis Manager module 344 of FIG. 3) the retrieved media resources to select a subject to be rated by the AUR system. At block 404, a processor-based device begins performing automated operations to select aggregation criteria for the subject determined to be rated by the AUR system in block 402; such automated operations for the selection of aggregation criteria are described below with reference to FIG. 4B.

With reference to FIG. 4B: at block 406, a processor-based device identifies a subset of media resources associated with and/or otherwise relevant to an ecological impact of the selected subject, and at block 408 generates a listing of URLs (and/or other resource identifiers) corresponding to the identified subset of such media resources. At block 410, a processor-based device identifies a subset of media resources associated with and/or otherwise relevant to consumer reviews of the selected subject, and at block 412 generates a listing of URLs (and/or other resource identifiers) corresponding to the identified subset of such media resources. At block 414, a processor-based device identifies a subset of media resources associated with and/or otherwise relevant to critic reviews of the selected subject, and at block 416 generates a listing of URLs (and/or other resource identifiers) corresponding to the identified subset of such media resources.

The routine 400 proceeds to block 418, in which a processor-based device identifies key content from the media resources corresponding to each of the subsets of media resource identifiers respectively identified in blocks 408, 412, and 416. After the identifying of the key content, the routine proceeds to block 420, in which a processor-based device generates a review dataset based on that identified key content for further processing by the AUR system. The routine 400 then proceeds to block 422 to perform automated operations for Aggregation Criteria Analysis; such automated operations are described below with reference to FIG. 4C.

With reference to FIG. 4C: at block 424, a processor-based device identifies additional dataset opportunities, such as by analyzing the media resources earlier identified by the AUR system to determine additional media resource identifiers for analysis. In blocks 426, 428, and 430, a processor-based device classifies such additional media resource identifiers within respective subsets corresponding to critical reviews, customer reviews, and ecological impact in a manner similar to that described above with respect to the Aggregation Criteria Selection of FIG. 4B. At block 432, a processor-based device identifies positive and negative keywords associated with the relevant identified media resources. In blocks 434, 436, and 438, a processor-based device classifies such positive and negative keywords within respective subsets corresponding to critical reviews, customer reviews, and ecological impact. At block 440, a processor-based device identifies existing numeric ratings associated with the identified media resources, such as by determining whether such media resources already contain quantified ratings related to one or more aspects of the selected subject. In blocks 442, 444, and 446, a processor-based device classifies such existing numeric ratings within respective subsets corresponding to critical reviews, customer reviews, and ecological impact. The routine 400 then proceeds to block 448 to perform automated operations for Categorized Rating Generation; such automated operations are described below with reference to FIG. 4D.

With reference to FIG. 4D: at block 450, a processor-based device applies the additional dataset opportunities identified in block 424 of FIG. 4C. In blocks 452, 454, and 456, a processor-based device classifies such additional dataset opportunities within respective subsets corresponding to critical reviews, customer reviews, and ecological impact in a manner similar to that described elsewhere herein. At block 458, a processor-based device applies one or more weighting factors to each of the positive and negative keywords identified in block 432 of FIG. 4C; in blocks 460, 462, and 464, a processor-based device classifies such weighted keywords within respective subsets corresponding to critical reviews, customer reviews, and ecological impact. At block 466, a processor-based device applies one or more weighting factors to the existing numeric ratings identified in block 440 of FIG. 4C; in blocks 468, 470, and 472, a processor-based device classifies such weighted numeric ratings within respective subsets corresponding to critical reviews, customer reviews, and ecological impact. The routine 400 then proceeds to block 474, in which a processor-based device compiles all of the categorized scores into final categorized ratings, after which the routine proceeds to blocks 476, 478, and 480, in which a processor-based device separates such ratings into a critical score, a customer score, and an ecological impact score, respectively. The routine 400 then proceeds to block 482, in which a processor-based device produces the categorized ratings for further analysis.

Returning to FIG. 4A, the routine 400 then proceeds to block 484, in which a processor-based device compiles the categorized ratings into a “final” aggregated subject score. As noted elsewhere herein, this “final” aggregated subject score may comprise one or more of an initial computed score, a modified computed score based on subsequent analysis of additional sources and reviews, or a “final” computed score not subject to additional subsequent modification. The routine then proceeds to block 486, in which a processor-based device compiles a list of keywords for producing an aggregated review based on the media resources and data sets previously identified and analyzed by the AUR system. In block 488, and aggregated review based on the compiled keyword list is then published, as described in greater detail elsewhere herein.

Following block 488, the routine 400 proceeds to block 495 to determine whether to continue, such as in response to an explicit indication to terminate. If it is determined to continue, control returns to block 402 to identify an additional subject for rating by the AUR system (and/or to perform additional analysis of subsequent media resources identified as being relevant to a subject already rated by the AUR system); otherwise, the routine 400 proceeds to step 499 and ends.

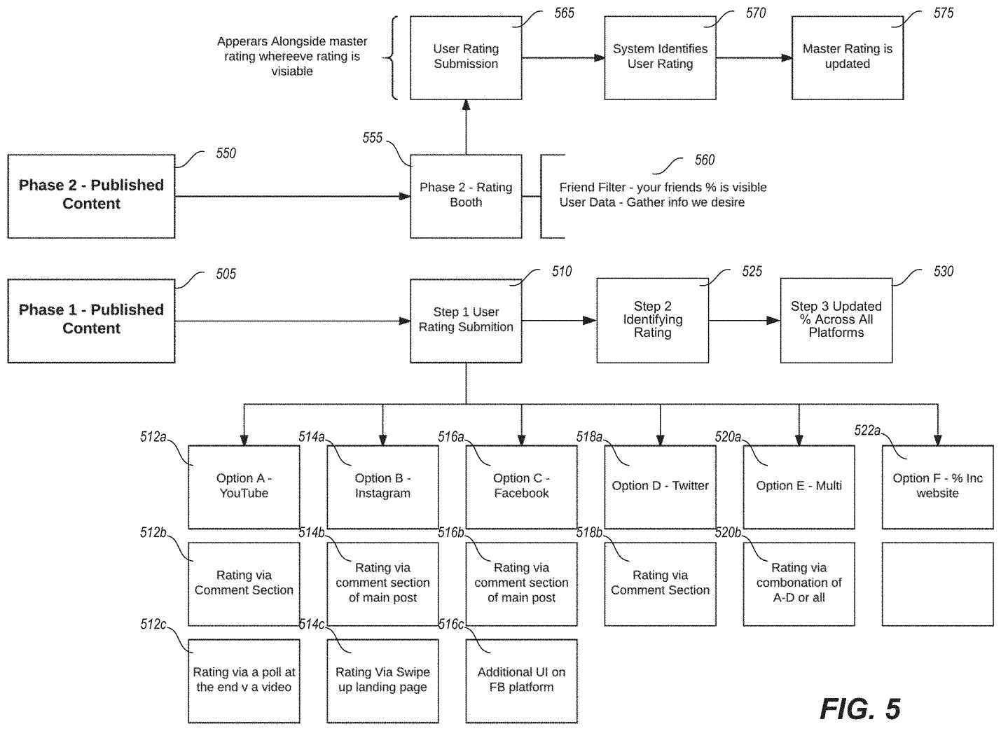

FIG. 5 is a block diagram illustrating an overview of additional operations according to an embodiment of an Automated Universal Ratings system in accordance with certain techniques described herein. Such additional operations will be apparent to those of ordinary skill in the relevant art upon a detailed review of FIG. 5 and other disclosure herein.

Those skilled in the relevant art will also appreciate that the Web pages and other data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

A computer-implemented method may be summarized as including receiving, by one or more computing systems configured to provide an automated ratings generation engine, indications of a plurality of media resource identifiers on multiple computer networks; retrieving, by the one or more configured computing systems, one or more media resources associated with each of the plurality of media resource identifiers; analyzing, by the one or more configured computing systems, the retrieved media resources to select a subject to be rated by the automated ratings generation engine; determining, by the one or more configured computing systems and based at least in part on the analyzing of the retrieved media resources, a subset of the retrieved media resources that each include one or more references to the selected subject; for each of the determined subset of retrieved media resources, quantifying, by the one or more configured computing systems, one or more characteristics of the selected subject based on the one or more references to the selected subject included by the retrieved media resource; and determining, by the one or more configured computing systems, one or more weighting factors for the retrieved media resource; generating, by the one or more configured computing systems, an initial aggregated rating for the selected subject, the generating of the initial aggregated rating including applying, for each of the determined subset of retrieved media resources, the one or more determined weighting factors to the one or more quantified characteristics; and publishing, by the one or more configured computing systems and to multiple additional computing systems over one or more computer networks, the generated initial aggregated rating for the selected subject. Quantifying one or more characteristics of the selected subject for at least one of the determined subset of retrieved media resources may include natural-language processing of the at least one retrieved media resource.

The computer-implemented method may further include, after the publishing of the generated initial aggregated rating for the selected subject, retrieving one or more additional media resources and analyzing the one or more retrieved additional media resources to generate a modified aggregated rating for the selected subject.

The computer-implemented method may further include analyzing the determined subset of retrieved media resources to determine one or more keywords associated with the selected subject in accordance with the included references to the selected subject. The determining of the one or more weighting factors for at least one retrieved media resource may include determining a relative credibility of the at least one retrieved media resource. The determining of the one or more weighting factors for at least one retrieved media resource may include determining a relative impact of the at least one retrieved media resource. Quantifying one or more characteristics of the selected subject may include quantifying an ecological impact of the selected subject. The determined subset of retrieved media resources for the selected subject comprises one or more of a group that may include a subject review, a social media reference, and an audiovisual recording.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

What is claimed is:

1. A computer-implemented method, comprising:
receiving, by one or more computing systems configured to provide an automated ratings generation engine, indications of a plurality of media resource identifiers on multiple computer networks;
retrieving, by the one or more configured computing systems, one or more media resources associated with each of the plurality of media resource identifiers;
analyzing, by the one or more configured computing systems, the retrieved media resources to select a subject to be rated by the automated ratings generation engine;
determining, by the one or more configured computing systems and based at least in part on the analyzing of the retrieved media resources, a subset of the retrieved media resources that each include one or more references to the selected subject;
for each of the determined subset of retrieved media resources,
quantifying, by the one or more configured computing systems, one or more characteristics of the selected subject based on the one or more references to the selected subject included by the retrieved media resource; and
determining, by the one or more configured computing systems, one or more weighting factors for the retrieved media resource;
generating, by the one or more configured computing systems, an initial aggregated rating for the selected subject, the generating of the initial aggregated rating including applying, for each of the determined subset of retrieved media resources, the one or more determined weighting factors to the one or more quantified characteristics; and
publishing, by the one or more configured computing systems and to multiple additional computing systems over one or more computer networks, the generated initial aggregated rating for the selected subject.

2. The computer-implemented method of claim 1, wherein quantifying one or more characteristics of the selected subject for at least one of the determined subset of retrieved media resources includes natural-language processing of the at least one retrieved media resource.

3. The computer-implemented method of claim 1 further comprising, after the publishing of the generated initial aggregated rating for the selected subject, retrieving one or more additional media resources and analyzing the one or more retrieved additional media resources to generate a modified aggregated rating for the selected subject.

4. The computer-implemented method of claim 1, further comprising analyzing the determined subset of retrieved media resources to determine one or more keywords associated with the selected subject in accordance with the included references to the selected subject.

5. The computer-implemented method of claim 1, wherein the determining of the one or more weighting factors for at least one retrieved media resource includes determining a relative credibility of the at least one retrieved media resource.

6. The computer-implemented method of claim 1, wherein the determining of the one or more weighting factors for at least one retrieved media resource includes determining a relative impact of the at least one retrieved media resource.

7. The computer-implemented method of claim 1, wherein quantifying one or more characteristics of the selected subject includes quantifying an ecological impact of the selected subject.

8. The computer-implemented method of claim 1, wherein the determined subset of retrieved media resources for the selected subject comprises one or more of a group that includes a subject review, a social media reference, and an audiovisual recording.
